(19) United States
(12) Patent Application Publication
(10) Pub. No.: US 2017/0004368 A1
(43) Pub. Date: Jan. 5, 2017

(54) SYSTEM AND METHOD FOR BIOMETRIC DETECTION BASED ON SWEAT DUCTS

(71) Applicants: NETEERA TECHNOLOGIES LTD., Jerusalem (IL); YISSUM RESEARCH DEVELOPMENT COMPANY OF THE HEBREW UNIVERSITY OF JERUSALEM, Jerusalem (IL)

(72) Inventors: Yuri FELDMAN, Jerusalem (IL); Paul BEN ISHAI, Modiin (IL); Alexander PUZENKO, Jerusalem (IL); Haim GOLDBERGER, Modiin (IL)

(73) Assignees: NETEERA TECHNOLOGIES LTD.; YISSUM RESEARCH DEVELOPMENT COMPANY OF THE HEBREW

(21) Appl. No.: 14/924,752

(22) Filed: Oct. 28, 2015

Related U.S. Application Data
(60) Provisional application No. 62/188,670, filed on Jul. 5, 2015.

(51) Int. Cl. G06K 9/00; G06K 9/62; G06K 9/46; G06K 9/20

(52) U.S. Cl. CPC G06K 9/00885; G06K 9/209; G06K 9/6201; G06K 9/2036; G06K 9/4652; G06K 2009/00932

(57) ABSTRACT

A method of identifying an individual based on the individual's sweat duets, including recording one or more images of the sweat ducts of a selected position on the individual's skin with a camera that forms images from electromagnetic signals in the sub terahertz frequency range, and transferring the one or more images to a computer for processing.

### RELATED APPLICATIONS

This application claims priority under 35 U.S.C. 120 from U.S. provisional application No. 62/188670 filed on Jul. 5, 2015, the disclosure of which is incorporated herein by reference.

### TECHNICAL FIELD

The present invention relates to biometric detection of an individual based on the distribution of their sweat ducts and to the identification of changes in the individual's emotional state.

### BACKGROUND

It is common nowadays to apply biometric recognition systems on people to verify their identity. For example law enforcement forces record the fingerprints of people to verify their identity. Likewise at border checkpoints many countries record biometric information to enhance identification.

Additionally, many times border officials give people questionnaires and/or ask them questions, while trying to determine if they answer truthfully. However determining if the person is lying or stressed by the questions is very subjective.

Human sweat ducts have a coiled structure that allows them to act as a helical antenna in the frequency region of about 0.1 to 0.9 THz. The human body fills the sweat ducts with water and ionized minerals making them electrically active. Additionally, fast proton hopping is believed to influence the high frequency response in the THz region. The electrical properties of the sweat ducts are influenced by the persons physiological state, for example if the person is under stress (metal, physical or emotional) the reflection coefficients of the sweat ducts will change.

A person generally has between 10-50 sweat ducts per mm square on the surface of the skin. Certain areas of a person's body have a higher density and certain areas have a lower density. However the actual distribution in similar body areas differs from person to person. It would thus be desirable to be able to define a system and method to uniquely identify a person based on the patterns of their sweat ducts and their high frequency electromagnetic activity. Furthermore it would be useful to use the electromagnetic activity of the sweat ducts to identify changes in the person's physiological, mental and emotional state.

### SUMMARY

An aspect of an embodiment of the disclosure relates to a system and method for identifying an individual based on the individual's sweat ducts. The system includes a terahertz camera that records electromagnetic waves in the sub terahertz frequency range having a frequency of between about 0.1 THz and 0.9 THz. The sweat ducts respond electromagnetically to waves having this frequency range. The camera is used to take one or more images of a selected position on the individual's skin, and based on the fact that each area on the skin includes a unique distribution of sweat duct density, the resulting image can be used to uniquely identify the individual. The recorded images are transferred to a computer for further processing. The computer may store the images in a database, compare them to previously recorded images or images provided in an identity card of the individual. Thus the computer may identify the individual or verify that the individual fits the information in the identity cards that he/she is carrying.

In some embodiments of the disclosure, a video or sequence of images is recorded. Optionally, the recording ma be performed during a live interaction with the individual or live monitoring session of the individual. Optionally, the sequence of images may be analyzed by comparing one image to another to identify if the shades or patterns in the image are shifting, for example becoming darker or lighter. In an exemplary embodiment of the disclosure, the computer may identify an extent of shades or patterns change and analogously determine a level of stress of the individual. The system may provide various real-time indications depending on the application being implemented, for example the system may be used as a lie detector, or to monitor a patient that is either conscious or unconscious. Optionally, the system may provide audio or visual indications to alert an operator of the system regarding changes in the physiological state of the individual being monitored.

There is thus provided according to an exemplary embodiment of the disclosure, a method of identifying an individual based on the individual's sweat ducts, comprising:

Recording one or more images of the sweat ducts of a selected position on the individual's skin with a camera that forms images from electromagnetic signals in the sub terahertz frequency range; and

Transferring the one or more images to a computer for processing.

In an exemplary embodiment of the disclosure, additionally comparing the images to previously recorded images of people to identify the individual based on the individuals sweat duct distribution. Optionally, additionally comparing the images to information on an identity card of the individual to verify that the individual matches the identity card.

In an exemplary embodiment of the disclosure, additionally illuminating the skin of the individual with a sub terahertz radiation source while recording the e or more images. Optionally, the sub terahertz frequency range includes electromagnetic signals with a frequency of between about 0.1 THz to 0.9 THz.

In an exemplary embodiment of the disclosure, the one or more images include a sequence of images; and analyzing the sequence of images to identify chromatic changes as a function of time. Optionally additionally, identifying an increase or decrease in a stress level of the individual based on the chromatic change. In an exemplary embodiment of the disclosure, additionally determining an extent of the chromatic change. Optionally, additionally determining if the extent of the chromatic change exceeds a threshold value. In an exemplary embodiment of the disclosure, additionally providing real time feedback based on the analysis.

There is further provided according to an exemplary embodiment of the disclosure, a system for biometric detection based on an individual's sweat ducts, comprising:

A camera that records images of the sweat ducts from a selected position on an individual's skin based on electromagnetic waves in the sub terahertz frequency range; and

A computer that receives the recorded images from the camera for processing.

In an exemplary embodiment of the disclosure, the computer is programed to compare the images to previously recorded images of people to identify the individual based on the individual's sweat duct distribution. Optionally, the computer is programed to compare the images to information on an identity card of the individual to verify that the individual matches the identity card.

In an exemplary embodiment of the disclosure, the skin of the individual is illuminated with a sub terahertz radiation source while the camera records the one or more images. Optionally, the sub terahertz frequency range includes electromagnetic signals with a frequency of between about 0.1 THz to 0.9 THz. In an exemplary embodiment of the disclosure, the one or more images include a sequence of images; and the sequence of images are analyzed to identify chromatic changes as a function of time. Optionally, the computer identifies an increase or decrease in a stress level of the individual based on the chromatic change. In an exemplary embodiment of the disclosure, the computer determines an extent of the chromatic change. Optionally, the computer determines if the extent of the chromatic change exceeds a threshold value. In an exemplary embodiment of the disclosure, the computer provides real time feedback based on the analysis.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear. It should be noted that the elements or parts in the figures are not necessarily shown to scale such that each element or part may be larger or smaller than actually shown.

FIG. 1 is a schematic illustration of sweat ducts on an individual's skin, according to an exemplary embodiment of the disclosure;

FIG. 2A is a schematic illustration of sweat duct distribution in an area on an individual's hand, according to an exemplary embodiment of the disclosure;

FIG. 2B is a schematic illustration of a recorded image of an area with sweat ducts on an individual's hand, according to an exemplary embodiment of the disclosure;

FIG. 3 is a schematic illustration of a system for biometric detection of an individual, according to an exemplary embodiment of the disclosure; and

FIG. 4 is a flow diagram of a method of biometric detection, according to an exemplary embodiment of the disclosure.

### DETAILED DESCRIPTION

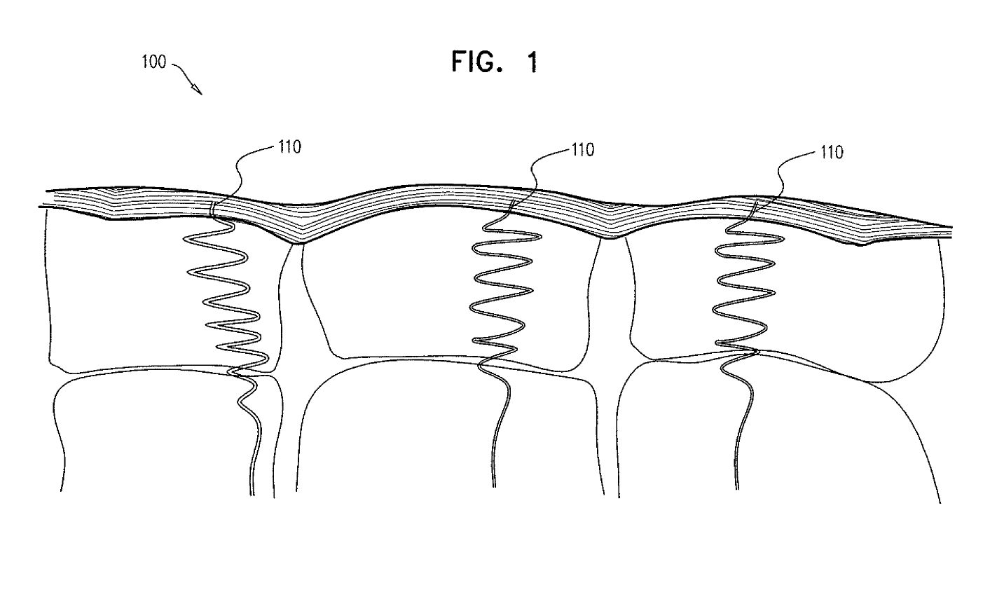

FIG. 1 is a schematic illustration of sweat ducts 110 on an individual's skin 100 having a stratum-corneum, dermis and epidermis layer, according to an exemplary embodiment of the disclosure. Optionally, each sweat duct 110 is filled with water and ionized salts/minerals depending on the physiological state of the individual. An electrical response to an incoming electromagnetic wave in the frequency range 0.1 to 0.9 THZ is due in a large part to the presence of free proton hopping in the water filled, interior. Optionally, the presence of salt/minerals in the water disrupts the response, thereby allowing more or less response depending on the salt/mineral level. Accordingly, the electromagnetic response of each duct to an electromagnetic signal in the sub THz frequency range (e.g. about 0.1 to 0.9 THz) is influenced by the contamination level of the sweat duct.

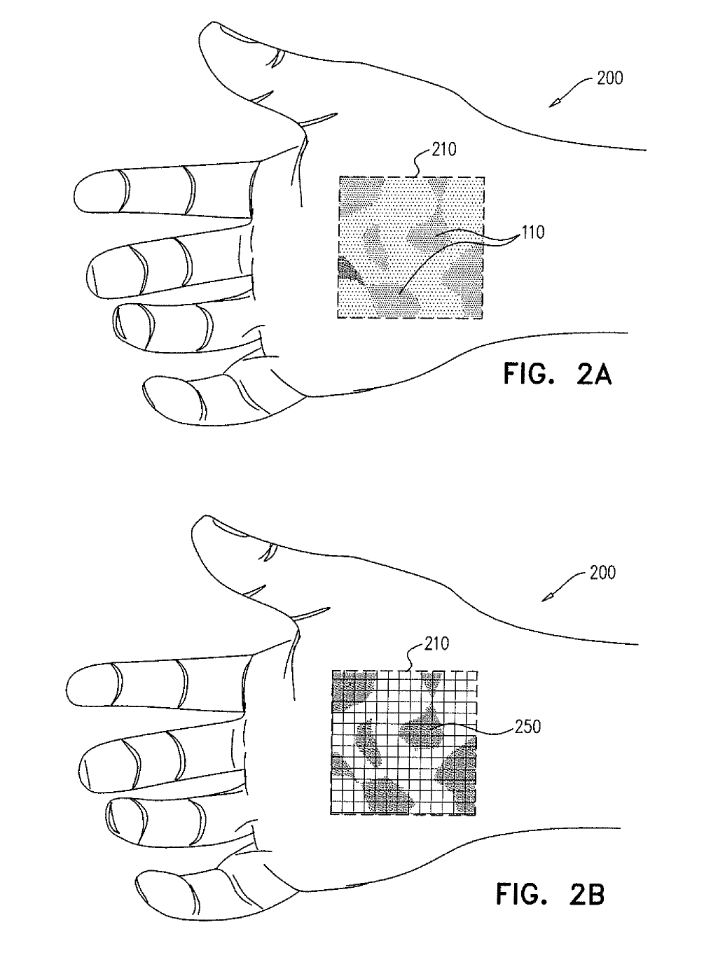

FIG. 2A is a schematic illustration of sweat duct 110 distribution in an area 210 on an individual's hand 200 and FIG. 2B is a schematic illustration of a recorded image 250 of the area 210 on the individual's hand 200, according to an exemplary embodiment of the disclosure. As evident from FIG. 2A some areas are densely populated with sweat ducts 110 and some areas are loosely populated.

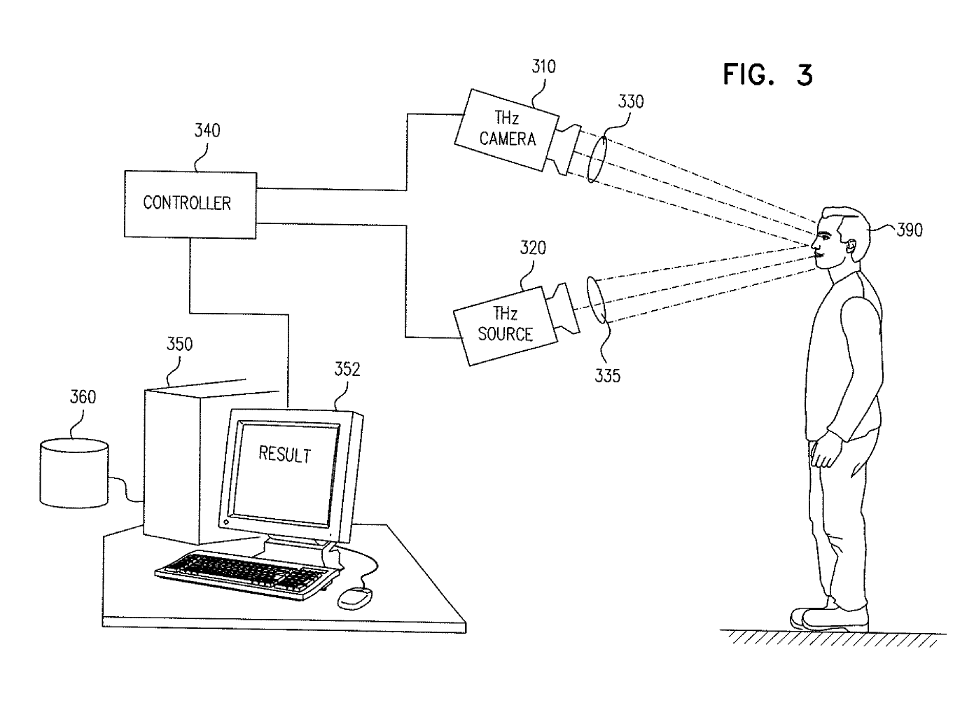

FIG. 3 is a schematic illustration of a system 300 for biometric detection of an individual 390, according to an exemplary embodiment of the disclosure. In an exemplary embodiment of the disclosure, a terahertz camera 310 (e.g. TeraSense 1024, by TeraSense Ltd from California USA) is used to form the recorded image 250 in area 210 on an individual's skin 100. For example the camera 310 may be used to take an image 250 of a specific area 210 on an individual's hand 200 or face. FIG. 2B shows the area 210 of FIG. 2A on the individual's hand 200 as imaged by camera 310. In some embodiments of the disclosure, the individual 390 is additionally, actively illuminated by a THz source 320 while recording images 250, to enhance the response of the sweat ducts 110 for recording by camera 310. Alternatively, the image 250 is recorded based on the reflection of existing light/radiation or self-illumination of the sweat ducts.

In an exemplary embodiment of the disclosure, image 250 has darker areas with a high density of sweat ducts 110 and lighter areas with a low density of sweat ducts 110. Optionally, the darker and lighter areas enable comparison of an image from an individual to pre-stored images to determine the identity of the in an exemplary embodiment of the disclosure, the intensity of the signal reflected from each sweat duct 110 is influenced by the electrical response that is influenced by the electrical resistance/capacitance/inductance of the sweat duct 110 resulting from the physiological state of the individual 390. Optionally, when comparing a sequence of images 250 taken over a consecutive period of time by camera 310 the chromaticity/shading/patterns of the image 250 as a whole may change, for example become darker or lighter, or have a wavelength shift, depending on the physiological state of the individual 390 being recorded. Comparison of images 250 from a sequence of images (e.g. a video of an interview with an individual) enables determining if the individual 390 is subject to stress, for example due to questions that are being asked.

In some embodiments of the disclosure, a terahertz lens 330 is used to focus the camera 310 and/or a terahertz lens 335 is used to collimate a beam from the illuminating THz source 320. In some embodiments of the disclosure, a controller 340 controls the THz source 320 and/or the camera 310, for example selecting when to illuminate and/or when to record images 250. Optionally, the recorded images 250 are transferred to a general purpose computer 350 having a processor and memory for processing. In some embodiments of the disclosure, computer 350 may also control camera 310 and/or THz source 320. Alternatively, a dedicated electronic circuit may be used for controlling and/or processing. In an exemplary embodiment of the disclosure, the computer 350 may store the images in a database 360 for later use, for example to biometrically identify individual 390 in the future. Optionally, the current images 250 may be compared to information in the database 360 including biometric information of people to identify the current individual 390. Alternatively or additionally, the current images 250 may be compared to information in a passport or ID card that may be in the possession of the individual 390. The computer 350 may also provide a visual indication (e.g. on a display 352 and/or provide an audio indication reflecting the results of the processing or providing instructions to a person interviewing the individual 390.

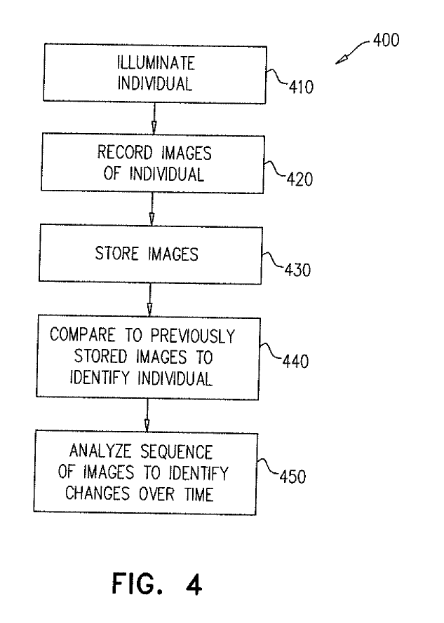

FIG. 4 is a flow diagram of a method of biometric detection 400, according to an exemplary embodiment of the disclosure, in some embodiments of the disclosure, an individual 390 is illuminated (410) by an electromagnetic signal with a frequency in the sub THz region, for example between 0.1 THz to 0.9 THz. While illuminating the individual 390 a camera 310 that records images in the sub THz range is used to record (420) one or more images 250 of the individual's skin 100. Optionally, the recording may be a video recording to be able to analyze changes in the sweat duets of the individual 390 over time. Alternatively, the recording may be a single image 250 or a sequence of images 250. In sonic embodiments of the disclosure, the recordings are performed without using a dedicated THz source 320 to illuminate the individual's skin 110.

In an exemplary embodiment of the disclosure, the one or more images are stored (430) in database 360 for future use or for current analysis. Optionally, analysis of the recordings may serve as a lie detector, by identifying sweat duct 110 activity causing the chromaticity/shading/patterns of the images or specific areas of the images as represented by camera 310 to shift up or down (e.g. become darker or lighter). In some embodiments of the disclosure, the recordings may serve as an analysis tool in medical treatment, for example by recording a patient's skin while non-conscious and detecting stress. Optionally, system 300 may provide real-time responses for example to notify a physician when the patient becomes more stressed than before or to notify an interrogator when there are indications that the individual 390 is lying. Optionally, the notification may include a score value giving indication as to a level of stress. The level may be positive or negative to indicate if the individual 390 is more stressed or less stressed than before.

In an exemplary embodiment of the disclosure, the recorded images are compared (440) to previously stored images to identify the individual 390, for example by comparing two dimensional matrices for similarity in sweat duct density. Alternatively, or additionally, the recorded images ma be stored with information related to the individual's identity as currently represented to the person interacting with the individual 390. The recorded information may be used to identify the individual 390 in the future, for example to prevent the individual 390 from appearing in the future with a different identity or from providing contradictory information.

In some embodiments of the disclosure, if a video or sequence of images are recorded, the images may be analyzed (450) relative to each other to determine if the chromaticity/shading/patterns of the resulting image 250 provided by camera 310 are shifting (e.g. becoming darker or lighter or subject to a red shift or blue shift or other type of change) and to what extent. Optionally, analysis may be performed in real-time or after recording depending on the application. In an exemplary embodiment of the disclosure, the information provides an indication regarding the physiological state of the individual 390. Optionally, the extent of the change may be compared to a threshold value to determine if it is significant or within the normal fluctuations of a person.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/We claim:

1. A method of identifying an individual based on the individual s sweat ducts, comprising:
recording one or more images of the sweat ducts of a selected position on the individual's skin with a camera that forms images from electromagnetic signals in the sub terahertz frequency range; and
transferring the one or more images to a computer for processing.

2. The method according to claim 1, further comprising comparing the images to previously recorded images of people to identify the individual based on the individual's sweat duct distribution.

3. The method according to claim 1, further comprising comparing the images to information on an identity card of the individual to verify that the individual matches the identity card.

4. The method according to claim 1, further comprising:
illuminating the skin of the individual with a sub terahertz radiation source while recording the one or more images.

5. The method according to claim 1, wherein the sub terahertz frequency range includes electromagnetic signals with a frequency of between about 0.1 THz to 0.9 THz.

6. The method according to claim 1, wherein the one or more images include a sequence of images; and analyzing the sequence of images to identify chromatic changes as a function of time.

7. The method according to claim 6, further comprising identifying an increase or decrease in a stress level of the individual based on the chromatic change.

8. The method according to claim 6, further comprising determining an extent of the chromatic change.

9. The method according to claim 8, further comprising determining if the extent of the chromatic change exceeds a threshold value.

10. The method according to claim 6, further comprising providing real time feedback based on the analysis.

11. A system for biometric, detection based on an individual's sweat ducts, comprising:
a camera that records images of the sweat ducts from a selected position on an individual's skin, based on electromagnetic waves in the sub terahertz frequency range; and
a computer that receives the recorded images from the camera for processing.

12. The system according to claim 11, wherein the computer is programed to compare the images to previously recorded images of people to identify the individual based on the individual's sweat duct distribution.

13. The system according to claim 11, wherein the computer is programed to compare the images to information on an identity card of the individual to verify that the individual matches the identity card.

14. The system according to claim 11, wherein the skin of the individual is illuminated with a sub terahertz radiation source while the camera records the one or more images.

15. The system according to claim 11, wherein the sub terahertz frequency range includes electromagnetic signals with a frequency of between about 0.1 THz to 0.9 THz.

16. The system according to claim 11, wherein the one or more images include a sequence of images; and the sequence of images are analyzed to identify chromatic changes as a function of time.

17. The system according to claim 16, wherein the computer identifies an increase or decrease in a stress level of the individual based on the chromatic change.

18. The system according to claim 16, wherein the computer determines an extent of the chromatic change.

19. The system according to claim 18, wherein the computer determines if the extent of the chromatic change exceeds a threshold value.

20. The system according to claim 16, wherein the computer provides real time feedback based on the analysis.
